(19) United States
(12) Patent Application Publication
(10) Pub. No.: US 2014/0180535 A1
(43) Pub. Date: Jun. 26, 2014

(54) METHOD FOR MONITORING THE FUNCTION OF A PARKING BRAKE IN A VEHICLE

(71) Applicants: Frank Baehrle-Miller, Schoenaich (DE); Dieter Blattert, Kirchheim/Neckar (DE)

(72) Inventors: Frank Baehrle-Miller, Schoenaich (DE); Dieter Blattert, Kirchheim/Neckar (DE)

(21) Appl. No.: 13/980,754

(22) PCT Filed: Dec. 13, 2011
(86) PCT No.: PCT/EP2011/072532

§ 371 Date: Oct. 10, 2013

(30) Foreign Application Priority Data
Jan. 26, 2011 (DE) 102011003183.9

(51) Int. Cl. B60T 17/22; B60Q 5/00; B60Q 1/00

(52) U.S. Cl. CPC B60T 17/22; B60Q 1/0017; B60Q 5/005
USPC 701/34.4

(57) ABSTRACT

In a method for monitoring the function of the parking brake in a vehicle, the movement state of the vehicle is monitored after the parking brake has been operated and a warning signal is generated in the case of a vehicle movement.

### BACKGROUND OF THE INVENTION

1. Field of the Invention

The present invention relates to a method for monitoring the function of a parking brake in a vehicle.

2. Description of the Related Art

Parking brakes are used for holding vehicles at a standstill. For this purpose, a clamping force is usually generated in the vehicle brake which may be generated, for example, according to DE 103 61 042 B3 via an actuator, designed as an electric brake motor, whose operation results in axial adjustment of a brake piston, which is the carrier of a brake lining, in the direction toward a brake disk. Operation of the parking brake usually provides visual feedback to the driver in the vehicle, showing the activated state of the parking brake. If the parking brake is to be operated manually or is using the foot, the counter force acting in the manual or foot lever conveys a haptic impression to the driver which may be assessed as an indication that the desired clamping force is in fact generated via the parking brake.

### BRIEF SUMMARY OF THE INVENTION

The object underlying the present invention is to use simple measures to reduce the risk potential in the case of an insufficient braking action of a parking brake in a vehicle.

The method according to the present invention relates to parking brakes in vehicles which are usually activated at a standstill of the vehicle either automatically or by the driver to generate a clamping force holding the vehicle. Hydraulic, pneumatic, and/or electromechanical parking brakes, e.g., parking brakes having an electric brake motor for generating the desired clamping force, come into consideration, an additional brake device being provided in the parking brake, if necessary, to be able to generate a clamping force additionally to the main actuator or alternatively, e.g., a hydraulically operable additional brake device which is in particular the hydraulic vehicle brake of the vehicle whose hydraulic pressure acts on the brake piston.

In the method for monitoring the function of the parking brake, the movement state of the vehicle is monitored after the parking brake has been operated and a warning signal is generated in the case of a vehicle movement. This may reduce the risk of the vehicle starting to move unintentionally, if the clamping force is insufficient to reliably hold the vehicle, and of endangering people and objects in the surroundings. The warning signal is, in particular, generated for people who are in the surroundings of the vehicle in a perceivable manner, preferably in the form of an acoustic and/or visual warning signal, e.g., by automatically triggering the flasher system, with the aid of light signals via the lighting system and/or by operating the signal horn. Additionally or alternatively, the warning signal may also be transferred to a device within and/or outside of the vehicle to trigger risk-reducing measures, e.g., within the vehicle to a regulating or control unit, via which a driver assistance system is activated, in particular a brake function, e.g., via an ESP (electronic stability program) device. Due to the automatic generation of the warning signal, the presence of the driver or another person in the vehicle is not necessary. The warning signal is generated independently of the driver or an operation by the driver if the prerequisites are present, i.e., the parking brake was operated and a vehicle movement was determined after the operation.

The movement state of the vehicle is, in particular, monitored with the aid of on board sensors, e.g., with the aid of the sensors in an ESP system or in an ABS (anti-lock braking) system. The sensors may monitor the movement state of the vehicle on the speed level and/or on the acceleration level. On the speed level, wheel speed sensors come into consideration, in particular, via which the wheel speeds of one or multiple vehicle wheels are monitored. On the acceleration level, the longitudinal and/or the transverse dynamic (s), in particular the longitudinal and/or the transverse acceleration of the vehicle, is/are monitored using corresponding acceleration sensors. A warning signal is generated if the threshold values assigned to the speed and acceleration values are exceeded.

As another condition or prerequisite for carrying out the method, the state of the drive engine of the vehicle may be monitored, if necessary. It may be advantageous to carry out the method for monitoring the function of the parking brake only if the drive engine of the vehicle is turned off. This ensures that the method is not carried out when the drive engine is running, since the presence of the driver in the vehicle may usually be assumed in this case. The state of the drive engine may be determined based on the ignition state in the case of an internal combustion engine. If the ignition is set to OFF, the method may be carried out; otherwise, the method is not carried out.

According to another advantageous embodiment, the monitoring of the movement state of the vehicle is only carried out for a defined, delimited monitoring time period. Usually, an insufficient clamping force for holding the vehicle is usually noticeable directly after the vehicle has been turned off, so that a monitoring of the movement state is not absolutely necessary beyond the monitoring time period. Within the monitoring time period, it may be determined whether the set clamping force does not reach the necessary clamping force level as well as whether the set clamping force decreases or drops below the necessary clamping force level.

The monitoring time period is either predefined as a fixed variable or, according to one advantageous embodiment, is established as a function of characteristics of the vehicle or the parking brake, and/or the vehicle surroundings. Considered are, in particular, a dependence on the road gradient, the monitoring time period increasing with an increasing road gradient, as well as a dependence on the temperature of the brake disk which is acted on by the parking brake in the vehicle, the monitoring time period increasing with increasing temperature of the brake disk. In both cases, both a discrete, incremental dependence of the monitoring time period on the road gradient or on the brake disk temperature and a functional, continuous dependence are possible. For the dependence on the downhill grade or the road gradient, three stages may, for example, be predefined having a gradient between 0% and 10%, a gradient between 10% and 20%, and a gradient above 20%, each gradient or downhill grade stage being assigned a constant monitoring time period and the monitoring time period increasing with an increasing downhill grade. In order to make dependences on a downhill grade or an uphill grade of the road independent, it may be advantageous to take into consideration the absolute value of the downhill grade or uphill grade in each case.

For the temperature, it is also possible to predefine three intervals, e.g., a brake disk temperature of <200° C., a brake disk temperature between 200° C. and 350° C., and a brake disk temperature above 350° C., the monitoring time period increasing with rising temperature. When taking into consideration the downhill grade and when taking into consideration the temperature, identical monitoring time periods for each of the three intervals may be established, e.g., a monitoring time period of 10 seconds for the shortest interval, a monitoring time period of 5 minutes for the medium interval, and a monitoring time period of 20 minutes for the longest interval.

If both the downhill grade of the road and the temperature dependence on the brake disk temperature are monitored, the longer monitoring time period is advantageously selected which results when the downhill grade or the brake disk temperature is checked. It is, however, also possible to set the monitoring time period to a maximum value, if the intervals deviate from one another during the monitoring of the downhill grade and the brake disk temperature, and one of the intervals has at least one medium time period.

### BRIEF DESCRIPTION OF THE DRAWINGS

FIG. 1 shows a section through an electromechanical parking brake for a vehicle, in which the clamping force is generated via an electric brake motor.

FIG. 2 shows a flow chart for carrying out the method for monitoring the function of the parking brake.

FIG. 3 shows the method sequence for establishing the monitoring time period as a function of the brake disk temperature.

FIG. 4 shows a partial chart for determining the maximum monitoring time period as a function of the uphill grade and the brake disk temperature.

### DETAILED DESCRIPTION OF THE INVENTION

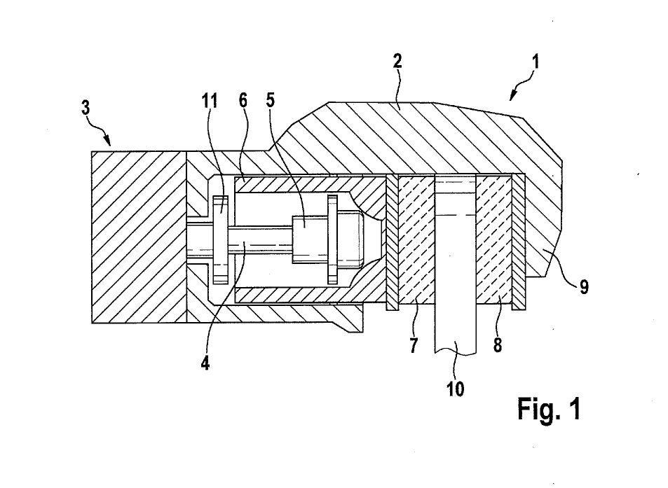

An electromechanical parking brake 1 for holding a vehicle at standstill is shown in FIG. 1. Parking brake 1 includes a brake caliper 2 having a caliper unit 9 which reaches over brake disk 10. As a final controlling element, parking brake 1 has an electric motor as brake motor 3 which rotatingly drives a spindle 4, on which a spindle component 5 is supported. When spindle 4 is rotated, spindle component 5 is displaced axially. Spindle component 5 moves within a brake piston 6, which is a carrier of a brake lining 7 which is pressed by brake piston 6 against brake disk 10. Another brake lining 8, which is held in a fixed position on caliper unit 9, is located on the opposite side of brake disk 10.

Within brake piston 6, spindle component 5 is able to move axially forward in the direction of brake disk 10 when spindle 4 rotates, or it is able to move axially rearward until a stop 11 is reached when spindle 4 rotates in the opposite direction. In order to s generate a clamping force, spindle component 5 acts upon the inner front side of brake piston 6, whereby brake piston 6, which is supported displaceably in parking brake 1, is pressed against the facing front side of brake disk 10 with its brake lining 7.

If necessary, the parking brake may be supported by a hydraulic to vehicle brake, so that the clamping force is composed of an electromotive component and a hydraulic component. In the case of hydraulic support, the back of brake piston 6 facing the brake motor is acted upon using hydraulic fluid under pressure.

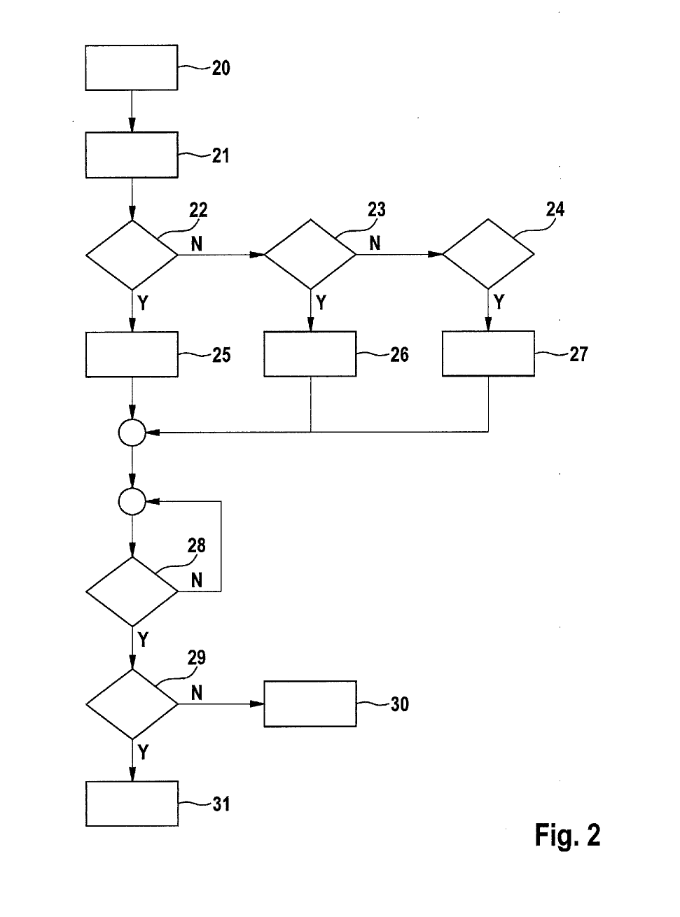

FIG. 2 illustrates the method sequence for monitoring the is function of the parking brake in the vehicle. In a first method step 20, it is initially determined whether the parking brake has been operated or activated and exerts a clamping force for holding the vehicle. In subsequent method step 21, it is checked, as another prerequisite for carrying out the method, whether the drive engine of the vehicle is turned off. This takes place based on a check of the ignition state; if the ignition is set to OFF, the method is continued; if not, the method is discontinued.

Carried-out method steps 22 through 27 relate to checking the road gradient and the assignment of a monitoring time period during which the monitoring of the function is carried out. The monitoring time period depends in this case on the road gradient.

In method step 22, it is queried whether the road gradient or uphill grade is in a first value range which accounts for a 0% to 10% downhill grade as an example. If this is the case, the Yes branch (“Y”) is followed to subsequent method step 25 in which the monitoring time period t_{detect}, within which the function of the parking brake is monitored after the vehicle has been turned off, is established to a first, comparably small value of ten seconds, for example. If the uphill grade according to query 22 is not in the first interval, the No branch (“N”) is followed to method step 23 in which it is queried whether the instantaneous road gradient is within a second value range which directly follows the first value range and includes a downhill grade range between 10% and 20%, for example. If the instantaneous road gradient is within this value range, the Yes branch is followed to method step 26 and monitoring time period t_{detect} is set to a medium value of 5 minutes, for example. Otherwise, the NO branch is followed to subsequent method step 24 in which it is queried whether the instantaneous uphill grade is in a higher value range which follows directly the medium value range and which is above a 20% downhill grade, for example. If this is the case, the Yes branch is followed to method step 27 and the monitoring time period is set to a long time period which accounts for 20 minutes, for example.

After a query in blocks 22 through 27 in which the duration of monitoring time period t_{detect} is established, the process is followed to subsequent method step 28 in which it is checked whether the already started monitoring of the function of the parking brake is still within the established monitoring time period. In step 28, the query takes place as to whether the monitoring time period is terminated. If this is not the case, the No branch is followed back to the start of method step 28 and the termination of the monitoring is queried repeatedly in cyclic intervals. If the monitoring time period has elapsed, the Yes branch is followed according to the method sequence.

The query in step 28 as to whether the monitoring should be terminated takes place in a comprehensive way or a way to be m processed in parallel, so that subsequent method step 29 may be carried out continuously within monitoring time period t_{detect}. Only upon termination of the monitoring time period is method step 29 not continued either.

In method step 29, a query takes place as to whether a vehicle movement is present. This may be carried out with the aid of on board sensors, e.g. , with the aid of the sensors of an ESP system in the vehicle, and includes the movement monitoring on the speed and/or acceleration level (s), it being possible to monitor both the longitudinal and the transverse dynamics of the vehicle state variables. According to one advantageous embodiment, it is provided to monitor the longitudinal speed and/or the longitudinal acceleration of the vehicle with the aid of the sensors.

If in step 29 a movement of the vehicle is determined, the Yes branch is followed to step 31 and a warning signal is generated which may be perceived in the surroundings of the vehicle . The warning signal is an acoustic and/or a visual warning signal which is generated by an automatic operation of the signal horn or of the flasher system, or of the vehicle lighting.

If, however, the query in step 29 results in a vehicle movement not being detected within the monitoring time period, the No branch is followed to method step 30; in this case, a warning signal is not output.

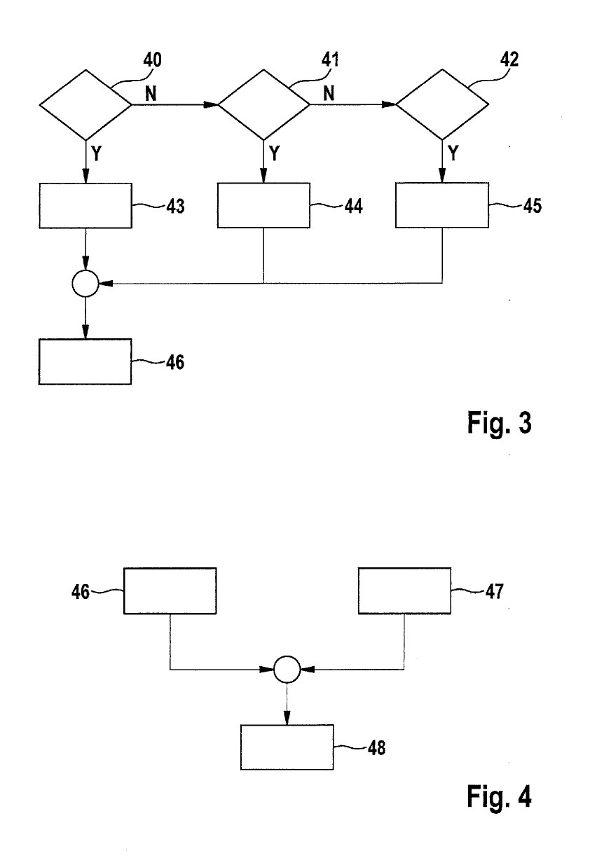

FIG. 3 shows a partial flow chart which is similar to method steps 22 through 27 from FIG. 2, but which, in contrast to FIG. 2, is not directed to a query regarding the road gradient, but to a query regarding brake disk temperature T_{disk}. Monitoring time period t_{detect} increases with rising temperature T_{disk} of the brake disk which is acted on by the parking brake.

In a first method step 40 according to FIG. 3, it is checked whether brake disk temperature T_{disk} is within a first lower temperature interval, which is lower than 200° C., for example. If this is the case, the Yes branch is followed to method step 43 and a short monitoring time period t_{detect} of 10 seconds, for example, is established. Otherwise, the No branch is followed to method step 41 in which it is checked whether brake disk temperature T_{disk} is in a higher temperature interval of 200° C. to 350° C., for example. If this is the case, the Yes branch is followed to method step 44 and monitoring time period T_{disk} is set to a medium time period of 5 minutes, for example. Otherwise, the No branch is followed to method step 42 and it is checked whether brake disk temperature T_{disk} is in a high temperature range of above 350° C. If this is the case, the Yes branch is followed to method step 45 and monitoring time period t_{detect} is established to a long time period of 20 minutes, for example. Subsequently, the process is followed to method step 46 after method steps 43 through 45.

Monitoring time periods t_{detect} which are established in method steps 43 through 45 advantageously correspond to the monitoring time periods which are established in method steps 25 through 27 during the check of the road gradient according to FIG. 2.

FIG. 4 corresponds to a partial flow chart which, similarly to FIG. 3, may also be integrated into the flow chart according to FIG. 2. The establishment of monitoring time period t_{detect} as a function of brake disk temperature T_{disk} is combined with the establishment of the monitoring time period as a function of the road gradient. According to FIG. 4, two method blocks 46 and 47 are combined to one joint method block 48, block 46 representing monitoring time period t_{detect} as a result of brake disk temperature T_{disk}, as indicated in FIG. 3, and block 47 representing monitoring time period t_{detect} as a result of the road gradient, as is illustrated in FIG. 2. For safety reasons, longer monitoring time period t_{detect} is selected from the two calculations as a function of the road gradient and the brake disk temperature. Both the selection of longer monitoring time period t_{detect} from the two ways of ascertainment and the establishment of a maximum monitoring time period are considered for the case that monitoring time periods t_{detect} from the two method branches differ. If, however, the monitoring time periods match, this value of the monitoring time period is advantageously maintained for the further method sequence.

1-14. (canceled)

15. A method for monitoring functioning of a parking brake in a vehicle, comprising:
detecting an actuation of the parking brake;
monitoring a movement state of the vehicle after the parking brake has been actuated; and
generating a warning signal in the case of movement of the vehicle.

16. The method as recited in claim 15, wherein the warning signal is at least one of an acoustic signal and a visual signal which is perceivable outside of the vehicle.

17. The method as recited in claim 16, wherein the method is carried out only if a drive engine of the vehicle is turned off

18. The method as recited in claim 17, wherein the monitoring of the movement state of the vehicle is carried out for a predefined monitoring time period.

19. The method as recited in claim 18, wherein the monitoring time period is determined at least as a function of a road gradient.

20. The method as recited in claim 19, wherein the monitoring time period is increased as the road gradient increases.

21. The method as recited in claim 19, wherein the monitoring time period is determined additionally as a function of a temperature of a brake disk which is acted on by the parking brake.

22. The method as recited in claim 21, wherein the monitoring time period is increased as the temperature of the brake disk increases.

23. The method as recited in claim 21, wherein the movement state of the vehicle is determined based on the vehicle speed.

24. The method as recited in claim 21, wherein the movement state of the vehicle is determined based on the vehicle acceleration.

25. A control unit for monitoring functioning of a parking brake in a vehicle, comprising:
means for detecting an actuation of the parking brake;
means for monitoring a movement state of the vehicle after the parking brake has been actuated; and
means for generating a warning signal in the case of movement of the vehicle.

26. The control unit as recited in claim 25, wherein control unit is a control unit of one of an anti-lock braking system or an electronic stability program of the vehicle.
